(19) United States
(12) Patent Application Publication
(10) Pub. No.: US 2006/0282830 A1
(43) Pub. Date: Dec. 14, 2006

(54) Analysis of the impact of application programs on resources stored in data stores

(75) Inventors: Jude Jacob Kavalam, Seattle, WA (US); Adam D. Stritzel, Redmond, WA (US); Nigel S. Keam, Redmond, WA (US); Timothy D. Noonan, Cary, NC (US); Valeriy V. Tsuryk, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/151,155

(22) Filed: Jun. 13, 2005

(51) Int. Cl. G06F 9/45

(52) U.S. Cl. 717/141

(57) ABSTRACT

System and method for analyzing the impact of interactions of application programs with resources stored in a data store. A method of the invention receiving a selection of the application programs from a user. The interactions of the resources by the selected application programs are identified. The method also determines access types for each of the interactions of the resources by the selected application programs. The method further selects a set of the identified interactions and the determined access types that corresponds to a map, said map including a predefined set of interactions having access types associated therewith. The map with the selected set of the identified interactions and the determined access types is provided to the user. For example, the map identifies potential resource conflicts. Alternatively, the method generates a report including the map.

### TECHNICAL FIELD

Embodiments of the present invention generally relate to the field of application program monitoring. In particular, embodiments of this invention relate to analyzing the impact of application programs on interacting with resources stored in a data store.

### BACKGROUND

With the popularity of personal computers and the continuing development in application programs, computers having installed software applications have become useful, convenient, and efficient tools in computer users' daily routines. For example, many consumer computer users use software installed in computers to perform tasks such as word processing, electronic communications (via electronic mail), multimedia usages, document exchange, or the like. For business users, business software handles and processes complex business transactions, performs repetitive calculations, or other tasks in a regular basis.

While software applications installed in the computer have been valuable to the users, these installed software applications frequently cause unexpected results as a result of conflicts with other installed software applications. For example, suppose the user has installed one or more software applications in a computer, such as application A and application B. While each of application A and application B performs well individually in the user's computer, applications may not work efficiently with each other. For instance, during execution of application A, application A may need to access a temporary file named temp1. However, when the computer executes application B, application B may need to access the temporary file temp1 and delete temp1 after the access. Consequently, when both applications are being executed, application A may not function properly when application B deletes the temp1 temporary file.

Some prior systems record interactions of an application with resources in a data store and identify the recorded interactions. While identifying the recorded interactions is useful, these prior systems fail to provide a better understanding of the impact of the interactions. For example, the prior systems may identify that application X has accessed a file in a memory of a computer. However, such identification does not determine whether application X's interaction with the file may interfere with another executing application or whether such interaction, coupled with other interaction may be acceptable and compatible with other applications.

### SUMMARY

Embodiments of the present invention overcome deficiencies of prior systems by identifying one or more interactions between applications and resources (e.g., files) in a data store such as a computer memory area. Embodiments of the invention also determine access types of each of the identified interactions. As such, systems and methods embodying the invention select a set of identified interactions and the determined access types that correspond to a set of predefined maps, each having a predefined set of interactions having access types associated therewith. The map with the selected set of the identified interactions and the determined access types to the user.

As such, embodiments of the present invention advantageously assist in analyzing the impact of resources used by applications. The invention enables software developers and programmers to identify potential resource conflicts and re-design applications to better work with the resources and with other applications to minimize incompatibilities. For example, software developers may reconfigure the type of access by an application to a resource in the data store so that the integrity of the resource is maintained.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary embodiment of a system for analyzing the impact of interactions of application programs with resources stored in a data store according to one embodiment of the invention.

FIGS. 2A-2G are exemplary screen displays illustrating configuration of the system illustrated in FIG. 1 to analyze the impact of interactions of application programs with resources stored in a data store according to one embodiment of the invention.

FIG. 2H is an exemplary diagram illustrating an exemplary summary report provided to the user according to one embodiment of the invention.

FIG. 3 is an exemplary flow chart illustrating a method of analyzing the impact of interactions of application programs with resources stored in a data store according to one embodiment of the invention.

FIG. 4 is a block diagram illustrating an exemplary computer-readable medium on which the invention may be stored.

FIG. 5 is a block diagram illustrating one example of a suitable computing system environment in which the invention may be implemented.

Appendix A illustrates a set of exemplary algorithms for determining the access types of each of the identified interactions or accesses of the resources by the selected applications, an exemplary table describing a report generated by embodiments of the invention, and a plurality of tables describing data relating to identified interactions.

Corresponding reference characters indicate corresponding parts throughout the drawings.

### DETAILED DESCRIPTION

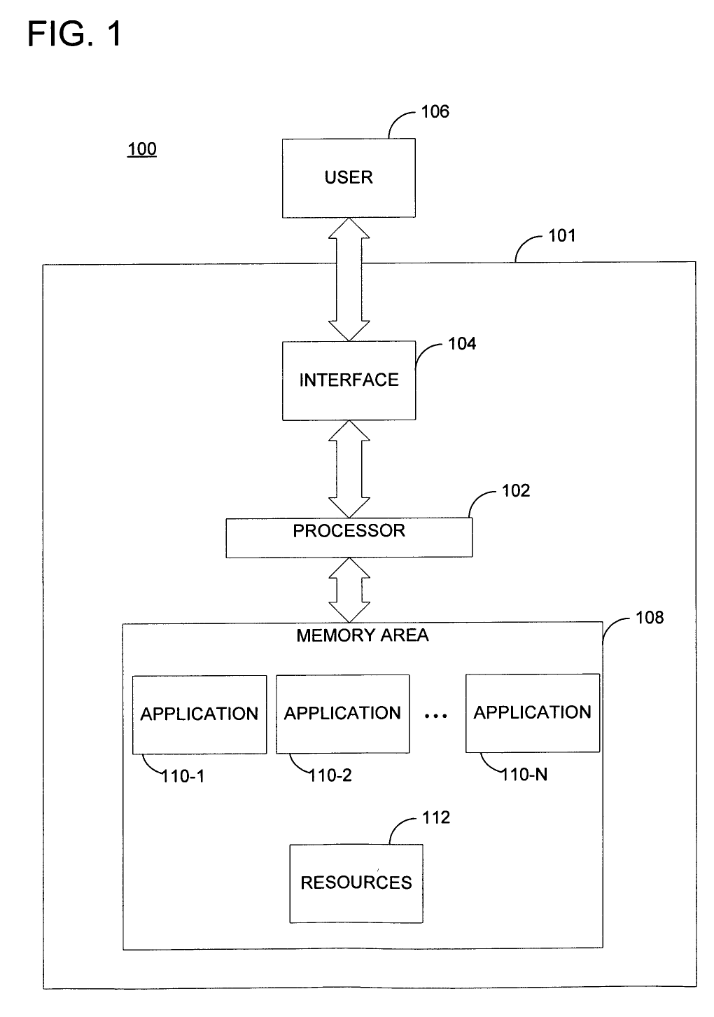

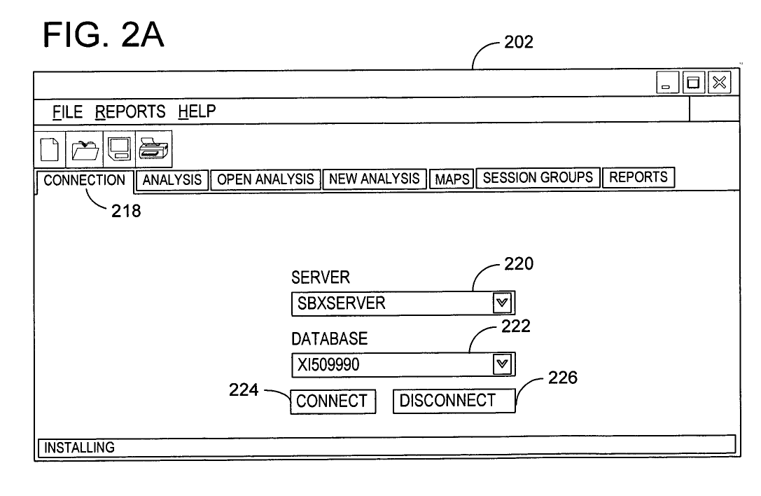

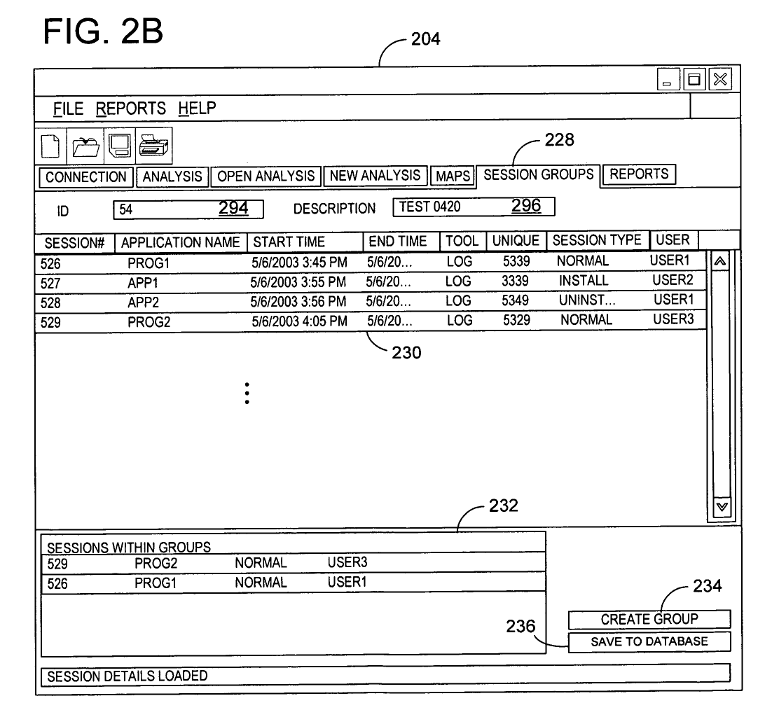

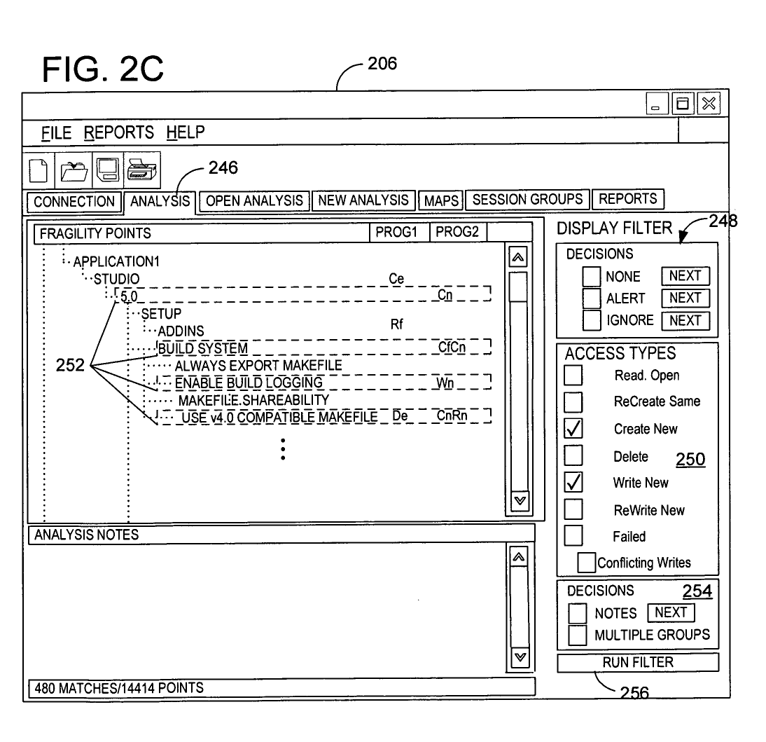

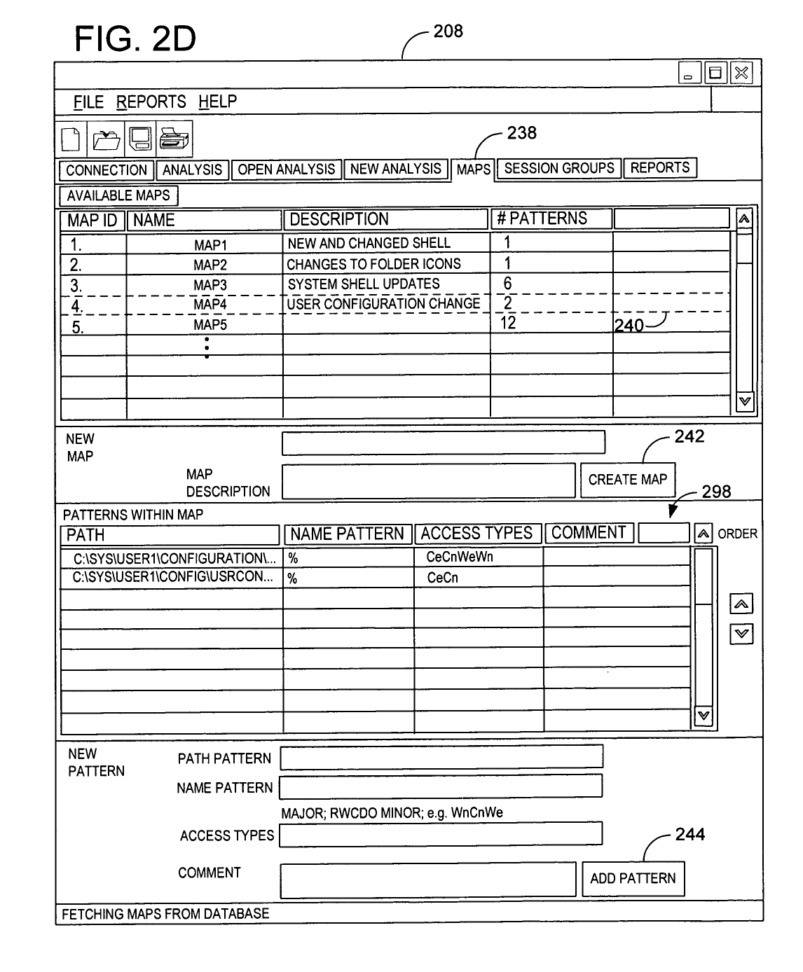

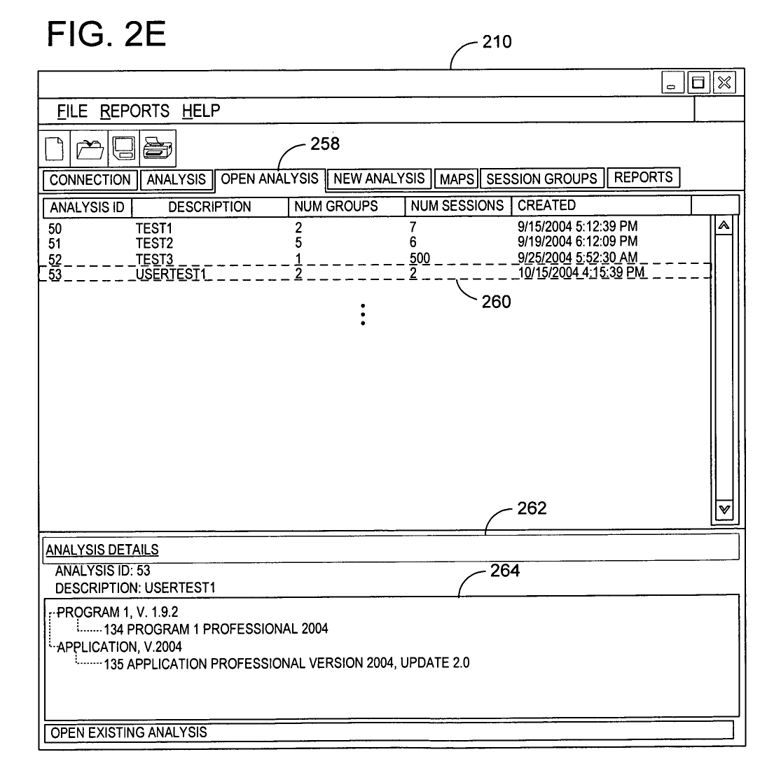

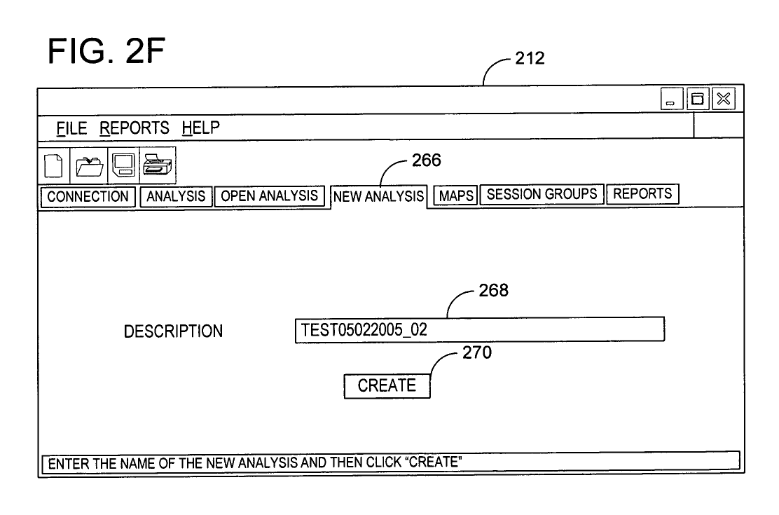

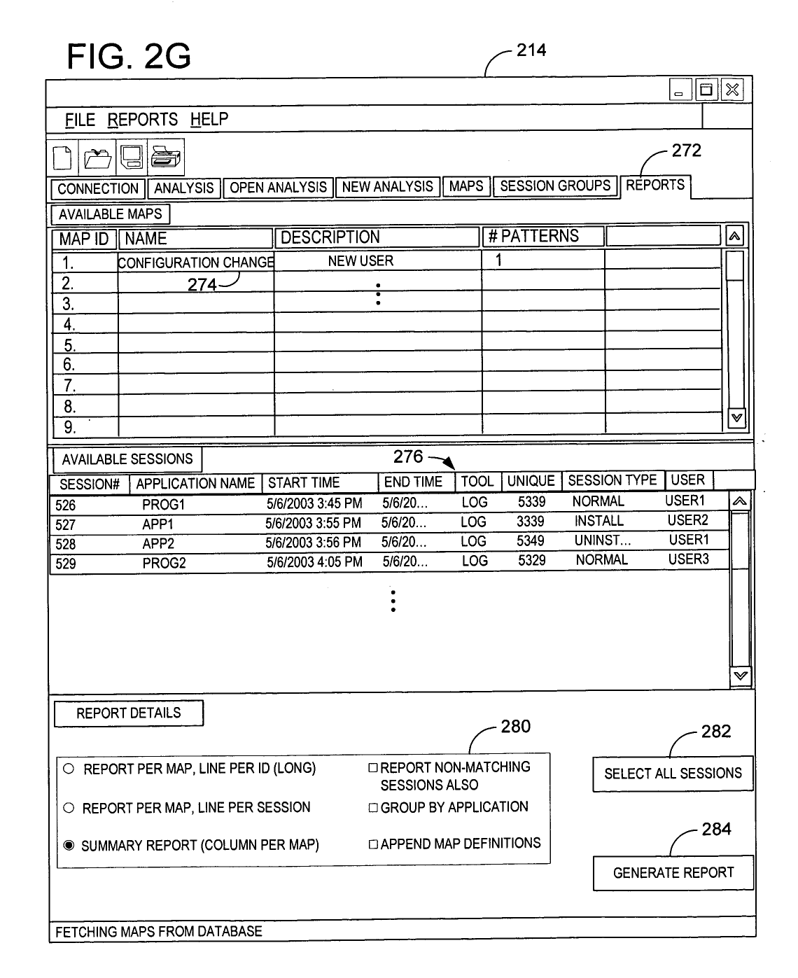

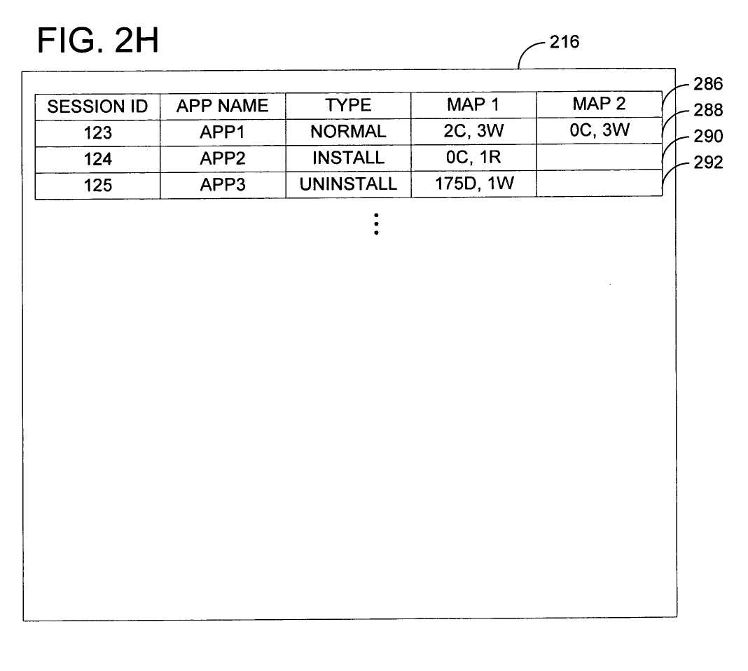

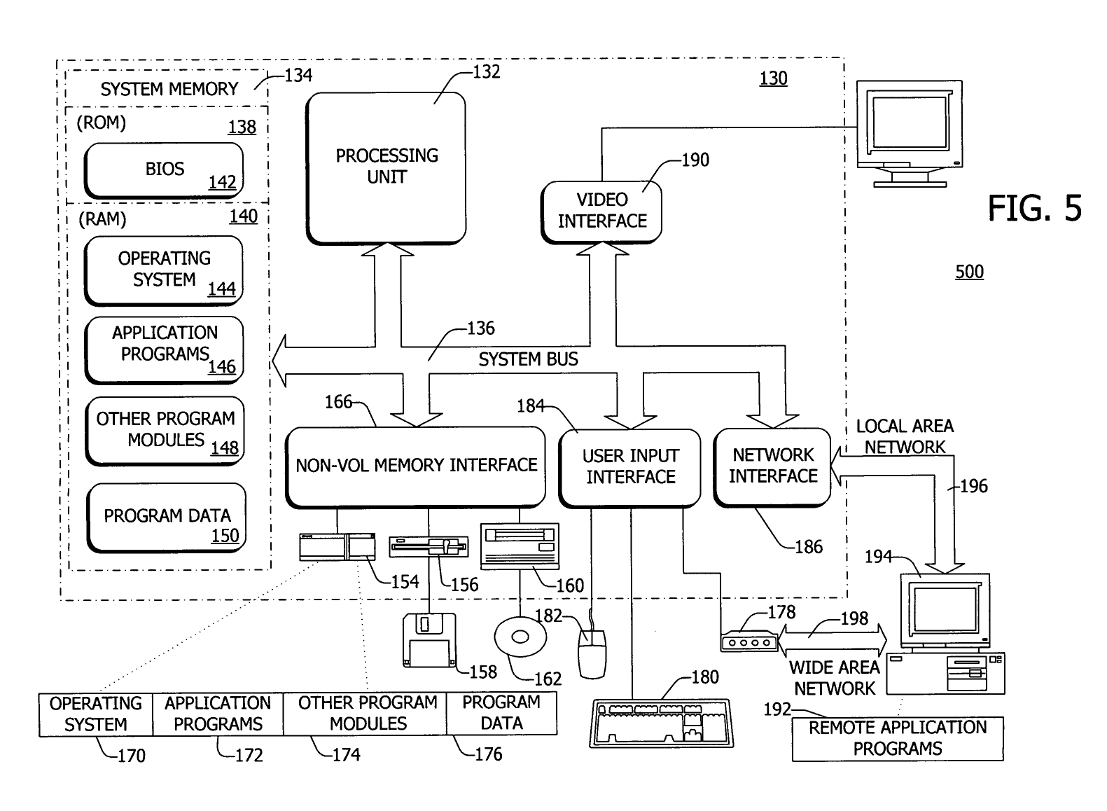

Referring first to FIG. 1, an exemplary diagram illustrates a system 101 for analyzing the impact of interactions of application programs with resources stored in a data store according to one embodiment of the invention. For example, the system 101 may be a computing system such as a computer 130 in FIG. 5, a computing device, a computer server, a plurality of computer servers, or other computing device that is capable of executing computer-executable instructions, applications, application software, computer-executable routines or code. In another embodiment, the system 101 includes computing devices in a distributed system in which the computing devices are connected by a common communication network, such as an intranet, an internet, or the like. The system 101 also includes a processor 102, an interface 104, and a memory area 108. The interface 104 may include a display such as a monitor 188 in FIG. 5 for displaying a graphical user interface (GUI), such as shown in FIGS. 2A-2G, and for interacting with a user 106. In another embodiment, the interface 104 may include an audible or visual means for interacting or exchanging data between a user and the system 101. The processor 102 includes a central processing unit, or a processing component capable of processing computer-executable instructions, routines, or codes. The memory area 108 may be a volatile or non-volatile memory (such as a system memory 134 or a non-volatile memory interface 166 of FIG. 5), or other computer-readable medium for storing data. In one embodiment, the memory area 108 includes a database structure or a data warehouse for storing data, a database server, or a plurality of database applications that provide data access to the processor 102 or the system 101. The memory area 108 also stores applications 110 which may perform various functions and operations in the system 101.

Still referring to FIG. 1, applications 110 may interact with the processor 102 and the memory area 108 in accessing or using resources 112 (e.g., files) in the memory area 108. For example, application 110-1 may read a file in the memory area 108 during execution of the application 110-1 or application 110-2 may modify a plurality of files in the memory area 108. As the applications 110 interact or use the resources 112, embodiments of the present invention analyze the impact of the interactions or the usages of the resources 112 by the applications 110. FIGS. 2A-2G illustrate screen displays configuring the system 101 to analyze the impact of interactions of application programs with resources stored in a data store according to one embodiment of the invention.

Referring now to FIG. 2A, an initial screen shot 202 enables the user 106 to analyze the application interactions. As shown in FIG. 2A, on a CONNECTION tab 218, the user 106 may connect to a server in a server drop-down list 220 or to a database from a database drop-down list 222 via a connect button 224. For example, the user 106 may be in a distributed or multi-computer computing environment where the system 101 is connected to the computing devices in the distributed computing environment via a common network, such as an internet, an intranet, or the like. In one example, by connecting to a server “SBXSERVER” from the server drop-down list 220 and a database “XI509990” from the database drop-down list 222, the user 106 may access the resources (such as the resources 112 of the system 101) of the server “SBXSERVER” or the database “XI5099960”.

Referring now to FIG. 2B, a screen shot 204 illustrates the contents of a “SESSION GROUPS” tab 228. In particular, the screen shot 204 illustrates four sessions with corresponding applications that are available for the user 106 to select as a session group. In particular, in the “SESSION GROUPS” tab 228, the user 106 selects sessions available to create a session group for analysis. For example, a session of an application includes execution of the application during a particular time interval (e.g., during a normal execution of the application, an installation of the application, and a un-installation of the application). As understood in the art, an “installation” of the application is a process in which an application is prepared for operation and execution by a processing unit (e.g., a CPU). Also, a “un-installation” of the application involves a process where the application, having installed in an execution environment or a computer-readable medium, is removed from the execution environment or the computer-readable medium by deleting files associated with the application.

To create a session group, the user 106 may initially enter an identification (ID) 294 and a description 296 of the desired session group. For example, the user may enter “54” as the session group ID and “Test 0420” as the description of the session group. Subsequently, the user 106 may select one or more sessions each having a corresponding application available to the user. As illustrated in FIG. 2B, at row 230, the user 106 selects a “Normal” session “529” which includes an application “PROG2”. The PROG2 was started at a time of May 6, 2003 4:05 PM with an end time May 6, 2003 5:05 PM. This information was logged by a “LOG” tool. The PROG2 application has a unique ID of 5329. In addition, the PROG2 application in session 529 is being used or has been used by USER3 under a normal execution of the application session. In this example, the user 106 also selects a ““Normal” session “526” which includes PROG1 to be included in the session group “54”. Table 1 provides” a list exemplary data fields available for the user 106.

TABLE 1
Exemplary Categories in a Session.

| Field Name | Field Type | Indexes | Description |
|---|---|---|---|
| Session GUID | GUID | | Globally Unique ID of this logging session |
| Session Id. | Serial | PK | ID for this session within this database |
| Start Date | DateTime | | Date and time the logging was started |
| End Date | DateTime | | Date and time the logging completed |
| Primary | String | | Name of main application being logged |
| Application | | | |
| Session | String | | User-entered description of the logging session |
| Description | | | |
| Notes | String | | Additional user-entered notes |
| Diff Based | Boolean | | True if log is derived by diff of start&end |
| System Wide | Boolean | | True if all processes being monitored |
| Aggregated | Boolean | | True if events are coalesced (counts >1) |
| Machine | String | | Machine type, size, etc |
| Information | | | |

Still referring to FIG. 2B, as the user 106 selects the session group 54 which includes applications PROG1 and PROG2, a “Sessions within Groups” display space 232 displays the selected sessions so that the user 106 may further review the session group selection. The user 106 may choose to continue to select additional sessions with corresponding applications. As the user 106 finishes the selection of the one or more sessions, the user may select a “CREATE GROUP” button 234 and/or a “SAVE TO DATABASE” button 236 to proceed with analysis of the impact of interactions of the sessions in the session group on resources such as resources 112.

Referring now to FIG. 2C, a screen display 206 illustrates determining access types for the interactions by applications in the selected session groups with resources. As illustrated, the user 106 selects an “ANALYSIS” tab 246 showing a plurality of resources used or accessed by the applications, PROG1 and PROG2, in the selected session group along with the access type of the interactions or usages. In particular, the illustrated example shown in FIG. 2C includes PROG1 and PROG2's usages of the resource “APPLICATION1”. In one embodiment, a system, such as the system 101, determines the access types of the identified interactions by the selected applications by reviewing how the resources have been operated, used, or accessed by the selected applications. Table 2 illustrates an exemplary set of access types operable with the system 101 in analyzing the impact of the usages of the resources by the selected applications.

TABLE 2
Exemplary Access Types.

| Access type abbreviation | Description |
|---|---|
| Cf | Create Failed |
| Ce | Create Existing |
| Cn | Create New |
| Ci | Create with unknown result |
| Of | Open Failed |
| Oe | Open Existing |
| On | Open New |
| Oi | Open with unknown result |
| Rf | Read Failed |
| Re | Read Existing |
| Rn | Read New |
| Ri | Read with unknown result |
| Wf | Write Failed |
| We | Write Existing |
| Wn | Write New |
| Wi | Write with unknown result |
| Df | Write Failed |
| De | Write Existing |
| Dn | Write New |
| Di | Write with unknown result |

Still referring to FIG. 2C, a set of access types 250 are presented to the user 106 to highlight the specific access types. As shown in FIG. 2C, the user 106 wishes to highlight (as shown by a dashed box 252) “Create New” and “Write New” access types. As such, the screen display 208 shows that resource “5.0” is highlighted because “PROG2” has performed a “Create New” operation while “PROG2” has accessed resource “ENABLE BUILD LOGGING” via a “Write New” operation. Appendix A illustrates an exemplary set of algorithms for determining the access types of each of the identified interactions or accesses of the resources by the selected applications.

In one embodiment, under the ANALYSIS tab 246, the interface 104 may visually indicate one or more potential conflicts between the selected applications by highlighting the determined-access types of the identified interactions or usages of the resources. For example, the user 106 may select a box “CONFLICTING WRITES” in the access types 250.

In another embodiment, the system 101 may filter the identified interactions or usages from the analysis. For example, while applications interact or use resources 112 at various times during their executions, one or more accesses may not create potential conflicts with other applications. For example, suppose application X routinely creates a temporary file temp1.tmp as a buffer storage file to record a time of various user-initiated events such as opening a file, printing a file, or the like. While such usage of the resources 112 of the system 101 may be noted, the user 106 does not wish to be reminded or be alarmed by such writing, reading, or creating operations by application X. As such, the user may choose one or more options (NONE, ALERT, or IGNORE) in a display filter section 248 and/or options (NOTES, MULTIPLE GROUPS) in a “DECISIONS” section 254. Once the user 106 is satisfied with the selection of filters, the user 106 may select a “RUN FILTER” button 256. With the user's selection to filter the identified access types, the interface 104 displays only the identified interactions having a particular access type to the user. In one embodiment, the system 101 identifies additional information from interactions. For example, Tables A2-A12 in Appendix A describe exemplary sets of metric categories determined by the system 101.

Referring now to FIG. 2D, a screen display 208 illustrates a “MAPS” tab 238 showing a set of maps, each having a set of access patterns. In one embodiment, one or more maps with a predefined set of access patterns are stored in the memory area 108 for the user 106. In another embodiment, a map may be defined as a set of known access patterns by applications. For example, a map includes a pre-defined set of interactions or access patterns having access types associated therewith. As highlighted by the user 106 at row 240, MAP4 is defined as a set of access patterns that correspond to a user configuration change. In addition, MAP4 indicates that there are two access patterns and the details of each of the two access patterns are displayed in section 298. For example, one of the access patterns is accessing a file, pswd.txt, stored in a path “C:\SYS\USER\CONFIGURATION\PASSWORD\pswd.txt” with the access types of “create existing”, “create new”, “write existing”, and “write new”. On the other hand, the second of the two access patterns is another file, USRCONFIG.ini, resource stored in the memory area 108 at a path “C:\SYS\USER1\CONFIG\DOCUMENT\USRCONFIG.ini” with the access types “create existing” and “create new”.

The user 106 may create a new map by selecting a “Create Map” button 242. In addition, the user 106 may further add new patterns to both existing maps and newly created maps by selecting an “Add Pattern” button 244 (e.g., the user 106 enters information for the new pattern such as a path of the pattern, a name of the pattern, access types associated with the pattern, and comments relating to the pattern).

Still referring to FIG. 2D, embodiments of the invention (e.g., the system 101) selects a set of the identified interactions and the determined access types that corresponds to a map. As such, the system 101 through its interface 104 provides the map with the selected set of the identified interactions and the determined access types to the user 106 to further identify or analyze conflicts in accessing resources between applications (to be discussed below).

Referring now to FIG. 2E, a screen display 210 illustrates an OPEN ANALYSIS tab 258 according to one embodiment of the invention. In particular, under the “OPEN ANALYSIS” tab 258, a plurality of existing analysis configurations is available for the user 106 to select. For example, the user may make a selection 260 by highlighting a previous analysis “USERTEST1”, created on Oct. 15, 2004 4:15:39 PM, having two groups and two sessions in the analysis. Also, as a result of the selection 260, an “Analysis Details” section 262 and a program section 264 display additional information associated with the analysis “USERTEST1”. For example, the program section 264 displays the two groups “Program 1” and “Application” and the two sessions “134 Program 1 Professional 2004” and “135 application Professional Version 2004, Update 2.0”.

FIG. 2F describes a screen display 212 showing the content of a “NEW ANALYSIS” tab 266. The user 106 may wish to create a new analysis of the impact of application accesses to the resources by entering a description in a “Description” box 268 and selecting a “Create” button. In one embodiment, after creating a new analysis configuration, the user 106 proceeds to the “SESSION GROUPS” tab 228 to select one or more sessions for inclusion in the session group.

FIG. 2G is a screen display 214 describing a “REPORTS” tab 272. For example, the “REPORTS” tab 272 provides one or more maps that are available to the user 106, such as the map in a row 274 for selection in creating a report. For example, the map with ID “1” has a name “Configuration Change”, a description “New User”, and one access pattern. Additionally, the “REPORTS” tab 272 makes one or more sessions available to the user 106 in a section 276. The user 106 may select one or more available sessions individually or the user 106 may use a “Select All Sessions” button 282 to select all available sessions. Consequently, to provide the user 106 with the map having with the selected set of the identified interactions (i.e., interactions indicated in each of the sessions) and the determined access types (i.e., access types and access patterns included in each of the maps), the invention provides a “Report Details” section 280 for the user 106 to select one or more report styles for the application impact analysis report. For example, the user 106 may choose one or more of the following options: “Report per map, line per identified interaction”, “Report per map, line per session”, “Summary report (column per map)”, “Report non-matching sessions also”, “Group by application”, and “Append map definitions”. Upon finishing selecting the map, the sessions, and the various options' the user 106 may select a “Generate Report” button to send a request through the interface 104 to the system 101 to generate the application impact analysis report.

By selecting the set of identified interactions and the determined access types that correspond to the map, embodiments of the invention identify potential resource conflicts. For example, as illustrated in FIG. 2D, the invention indicates, through the maps, to the user 106 that application programs (e.g., PROG1 AND PROG2) in a session group (e.g., session group 54) may have potential resource conflicts in accessing or using the resources (e.g., files “pswd.txt” and “USRCONFIG.ini”) because the access patterns of the application programs corresponds to one or more maps (e.g., MAP4). Consequently, software developers and programmers may understand application programs better and may resolve the conflicts by re-designing application programs to minimize incompatibilities.

Referring now to FIG. 2H, a diagram illustrates an exemplary summary report 216 generated by the invention. As illustrated, the report 216 includes a header row 286 including headings such as “Session ID”, “Application Name”, “Type”, “Map 1”, “Map 2”, or the like. The report 216 also includes three rows of sessions, such as row 288 listing session “123” as application “APP1”. In particular, in row 288, the report 216 shows that the session corresponds to a normal execution of the application “APP1” during which time there were two “Create” interactions or file accesses and three “Write” interactions of APP1 that match the access patterns of Map 1, while there are only three “Write” interactions that match the access patterns of Map 2. Similarly, at row 290, the report 216 shows that the session corresponds to an installation of the application “APP2” during which there is only one “Read” interaction that matches the access patterns of Map1 and no interactions that match the access patterns of Map 2. At row 292, the report 216 shows that the session corresponds to an un-installation of the application “APP3” during which there were 175 “Delete” interactions and one “Write” interaction of APP1 that match the access patterns' in Map and no interactions that match the access patterns of Map 2. Table A1 in Appendix A illustrates an exemplary report style of “Report per map, line per session”.

The layouts, configurations, compositions, or the naming of the tabs or functions as illustrated in the screen displays of FIGS. 2A-2G may be modified without departing from the scope of the invention. In addition, other functionalities or operations may be configured within the scope of the invention to further assist in analyzing the impact of interactions or usages of the resources by applications 112. Furthermore, the sequence of navigating among the screen displays as shown in FIGS. 2A-2G may vary as the sequence of navigation between different tabs as described here is for illustration purposes and is not limiting. Moreover, layouts or presentation styles of reports generated by embodiments of the present invention may be modified without departing from the scope of the invention.

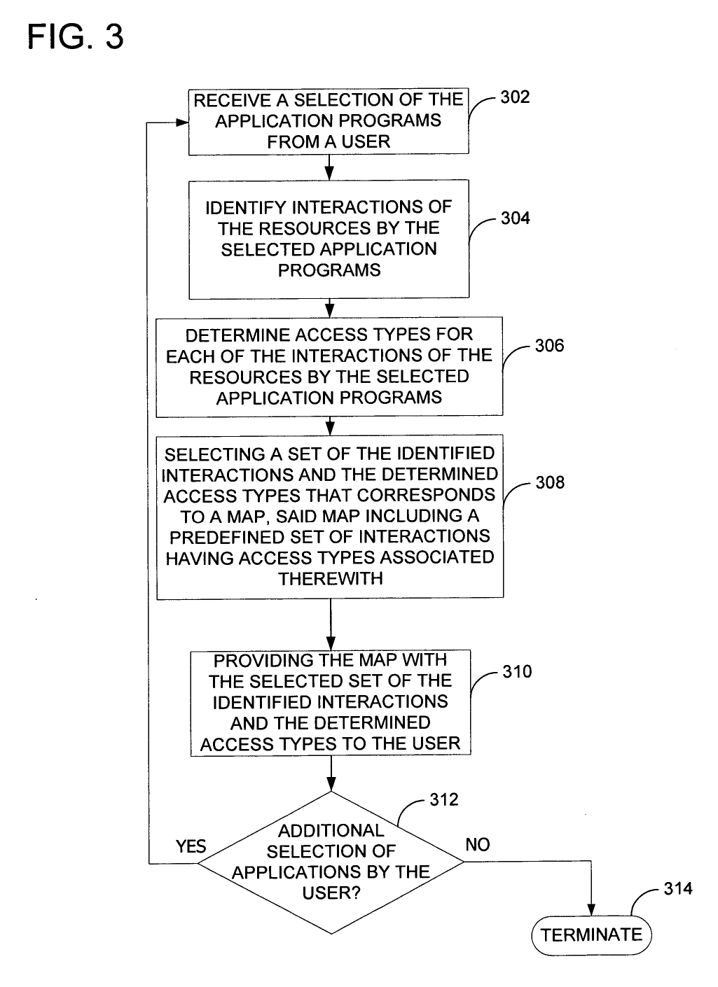

Referring now to FIG. 3, a flow chart illustrates a method of analyzing the impact of interactions of application programs with resources stored in a data store according to one embodiment of the invention. At 302, a method of the invention receives a selection of the application programs from a user. The method also identifies interactions of the resources by the selected application programs at 304. The Access types for each of the interactions of the resources by the selected application programs are determined at 306. A set of the identified interactions and the determined access types that corresponds to a map is selected at 308. The map includes a predefined set of interactions having access types associated therewith. The method of the invention further provides the map with the selected set of the identified interactions and the determined access types to the user at 310. At 312, the method determines whether there is any additional selection of applications by the user. If the determination is positive, the method proceeds to 302 to receive the additional selection of applications by the user. If the determination is negative, the analysis of impact of applications' interactions or usages of the resources is terminated.

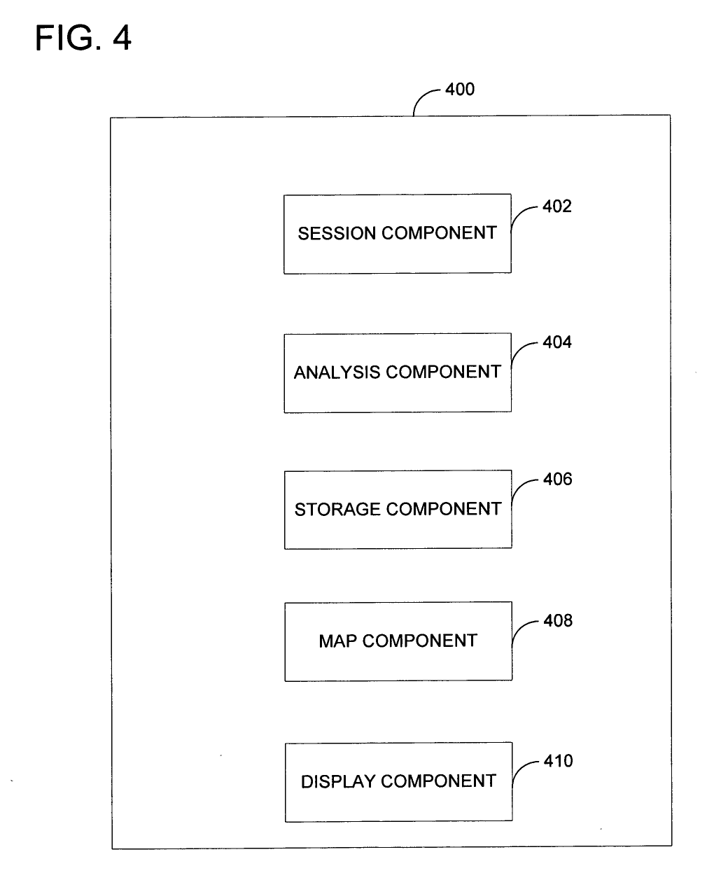

FIG. 4 is a block diagram illustrating an exemplary computer-readable medium 400 on which the invention may be stored. The computer-readable medium 400 includes a session component 402 for enabling a user to select applications. The computer-readable medium 400 also includes an analysis component 404 for identifying file accesses by the selected applications. The analysis component 404 determines an access type for each of the identified file accesses. The computer-readable medium 400 further includes a storage component 406 for storing a map. The map includes a predefined set of file accesses each having access types associated therewith. The computer-readable medium 400 includes a map component 408 for correlating one or more of the identified file accesses and the determined access types to the predefined set of file accesses in the map. The computer-readable medium 400 also includes a display component 410 for displaying the map having the correlated set of the identified file accesses and the determined access types to the user. As such, the analysis component 404 may generate a report to the user through the display component 410.

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 176, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in FIG. 3. In addition, computer 130 executes computer-executable instructions to implement the screen displays of FIGS. 2A-2G. Furthermore, the computer 130 includes means for enabling analysis of the impact of interactions of the applications with the resources as described in the system 101.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above system and method without departing from the scope of the invention, it is intended that all matter contained in the above description and shown in the accompanying drawings shall be interpreted as illustrative and not in a limiting sense.

### APPENDIX A

Exemplary set of algorithms is described below:

```
/*Create EventsAccessTypes table*/
Create table EventsAccessTypes
(
    [Event ID] int not null,
    [Cf] bit,
    [Ce] bit,
    [Cn] bit,
    [Ci] bit,
    [Of] bit,
    [Oe] bit,
    [On] bit,
    [Oi] bit,
    [Rf] bit,
    [Re] bit,
    [Rn] bit,
    [Ri] bit,
    [Wf] bit,
    [We] bit,
    [Wn] bit,
    [Wi] bit,
    [Df] bit,
    [De] bit,
    [Dn] bit,
    [Di] bit
)
/*Pre-populate the EventsAccessTypes by decoding */
/*the bit fields inform the [Events].[AccessTypes] bits information */
declare @EventID int
declare @AccessTypes int
declare @Cf bit
declare @Ce bit
declare @Cn bit
declare @Ci bit
declare @Of bit
declare @Oe bit
declare @On bit
declare @Oi bit
declare @Rf bit
declare @Re bit
declare @Rn bit
declare @Ri bit
declare @Wf bit
declare @We bit
declare @Wn bit
declare @Wi bit
declare @Df bit
declare @De bit
declare @Dn bit
declare @Di bit
declare cr SCROLL CURSOR FOR
    select [Event ID], [Access Types] from Events
begin transaction
OPEN cr
fetch next from cr into @EventID, @AccessTypes
while @@FETCH_STATUS = 0
begin
    /*decode the AccessType field*/
    set @Cf = (@AccessTypes & 1)
    set @Ce = (@AccessTypes & 256)
    set @Cn = (@AccessTypes & 65536)
    set @Ci = (@AccessTypes & 16777216)
    set @Of = (@AccessTypes & 2)
    set @Oe = (@AccessTypes & 512)
    set @On = (@AccessTypes & 131072)
    set @Oi = (@AccessTypes & 33554432)
    set @Rf = (@AccessTypes & 4)
    set @Re = (@AccessTypes & 1024)
    set @Rn = (@AccessTypes & 262144)
    set @Ri = (@AccessTypes & 67108864)
    set @Wf = (@AccessTypes & 8)
    set @We = (@AccessTypes & 2048)
    set @Wn = (@AccessTypes & 524288)
    set @Wi = (@AccessTypes & 134217728)
    set @Df = (@AccessTypes & 16)
    set @De = (@AccessTypes & 4096)
    set @Dn = (@AccessTypes & 1048576)
    set @Di = (@AccessTypes & 268435456)
    /*insert a record into the EventsAccessTypes*/
    insert into EventsAccessTypes values
    (
      @EventID,
      @Cf,
      @Ce,
      @Cn,
      @Ci,
      @Of,
      @Oe,
      @On,
      @Oi,
      @Rf,
      @Re,
      @Rn,
      @Ri,
      @Wf,
      @We,
      @Wn,
      @Wi,
      @Df,
      @De,
      @Dn,
      @Di
    )
    fetch next from cr into @EventID, @AccessTypes
end
commit transaction
deallocate cr
```

TABLE A1
Application Impact Analysis Report, style: Report per map, line per Session.

| Session | App | | # | # | | Value/ |
|---|---|---|---|---|---|---|
| ID | Name | Type | Creates | Writes | Key/Directory | Filename |
| 528 | Prog_1 | Install | 1 | 1 | RESOURCES\BSSTUB\SHELLEX\ | (Default) |
| | | | | | CONTEXTMENUHANDLERS\ | |
| | | | | | {C9C2F42A-63E2-11D0-BF73-00A024A8326E} | |
| 543 | Prog_2 | Install | 1 | 1 | RESOURCES\DIRECTORY\ | (Default) |
| | | | | | SHELLEX\COPYHOOKHANDLERS\HESHELL | |
| 606 | Prog_3 | Install | 1 | 1 | RESOURCES\DIRECTORY\ | (Default) |
| | | | | | SHELLEX\COPYHOOKHANDLERS\HESHELL | |
| 610 | Prog_4 | Install | 0 | 4 | RESOURCES\AGENT.PREVIEW.2\ | (Default) |
| | | | | | SHELLEX\PROPERTYSHEETHANDLERS\ | |
| | | | | | CHARACTERPAGE | |
| 623 | Prog_5 | Install | 7 | 7 | RESOURCES\.TIF\SHELLEX\ | (Default) |
| | | | | | {BB2E617C-0920-11D1-9A0B-00C04FC2D6C1} | |
| 675 | Prog_6 | Install | 0 | 4 | RESOURCES\SYSTEMFILEASSOCIATIONS\ | (Default) |
| | | | | | VIDEO\SHELLEX\CONTEXTMENUHANDLERS\ | |
| | | | | | Prog_6PLAYASPLAYLIST | |
| 696 | Prog_7 | Install | 1 | 1 | RESOURCES\*\SHELLEX\ | (Default) |
| | | | | | CONTEXTMENUHANDLERS\IMMENUSHELLEXT | |
| 700 | Prog_8 | Normal | 6 | 6 | RESOURCES\ADOBE.ILLUSTRATOR.EPS\ | (Default) |
| | | | | | SHELLEX\PROPERTYSHEETHANDLERS\AIPAGE | |
| 714 | Prog_9 | Install | 4 | 4 | RESOURCES\NAVNT\SHELLEX\ | (Default) |
| | | | | | CONTEXTMENUHANDLERS\ | |
| | | | | | {067DF822-EAB6-11CF-B56E-00A0244D5087} | |
| 721 | Prog_10 | Install | 0 | 4 | RESOURCES\AGENT.PREVIEW.2\ | (Default) |
| | | | | | SHELLEX\PROPERTYSHEETHANDLERS\ | |
| | | | | | CHARACTERPAGE | |
| 752 | Prog_11 | Install | 1 | 1 | RESOURCES\PEGFILE\ | (Default) |
| | | | | | SHELLEX\ICONHANDLER | |
| 839 | Prog_12 | Install | 1 | 0 | RESOURCES\CLSID\ | |
| | | | | | {955B7B84-5308-419C-8ED8-0B9CA3C56985}\ | |
| | | | | | SHELLEX\CONTEXTMENUHANDLERS\ | |
| | | | | | {955B7B84-5308-419C-8ED8-0B9CA3C56985} | |
| 849 | Prog_13 | Install | 1 | 0 | RESOURCES\CLSID\ | |
| | | | | | {955B7B84-5308-419C-8ED8-0B9CA3C56985}\ | |
| | | | | | SHELLEX\CONTEXTMENUHANDLERS\ | |
| | | | | | {955B7B84-5308-419C-8ED8-0B9CA3C56985} | |
| 850 | Prog_14 | Install | 4 | 8 | RESOURCES\CLSID\ | (Default) |
| | | | | | {CFFAADAE-3E1B-11D3-88AC-0080C7CA1A70}\ | |
| | | | | | SHELLEX\CONTEXTMENUHANDLERS\ | |
| | | | | | {78F00D91-3EC7-11D3-88AC-0080C7CA1A70} | |
| 858 | Prog_15 | Install | 0 | 19 | RESOURCES\OUTLOOK.TEMPLATE\ | (Default) |
| | | | | | SHELLEX\ICONHANDLER | |
| 917 | Prog_16 | Install | 4 | 4 | RESOURCES\DIRECTORY\ | (Default) |
| | | | | | SHELLEX\CONTEXTMENUHANDLERS\ | |
| | | | | | Prog_16 | |
| 921 | Prog_17 | Install | 0 | 8 | RESOURCES\WINZIP\ | (Default) |
| | | | | | SHELLEX\DROPHANDLER | |
| 944 | Prog_18 | Install | 4 | 4 | RESOURCES\DIRECTORY\ | (Default) |
| | | | | | SHELLEX\CONTEXTMENUHANDLERS\ | |
| | | | | | Prog_18 | |
| 945 | Prog_19 | Normal | 2 | 2 | RESOURCES\DIRECTORY\ | (Default) |
| | | | | | SHELLEX\CONTEXTMENUHANDLERS\ | |
| | | | | | Prog_19 | |
| 962 | Prog_20 | Install | 4 | 4 | RESOURCES\FOLDER\SHELLEX\ | (Default) |
| | | | | | CONTEXTMENUHANDLERS\Prog_20 | |
| 965 | Prog_21 | Install | 0 | 8 | RESOURCES\WINZIP\SHELLEX\ | (Default) |
| | | | | | DROPHANDLER | |
| 967 | Prog_22 | Uninstall | 0 | 2 | RESOURCES\FOLDER\SHELLEX\ | (Default) |
| | | | | | DRAGDROPHANDLERS\ | |
| | | | | | {BD472F60-27FA-11CF-B8B4-444553540000} | |
| 973 | Prog_23 | Install | 0 | 2 | RESOURCES\DRIVE\SHELLEX\ | (Default) |
| | | | | | PROPERTYSHEETHANDLERS\ | |
| | | | | | {5E44E225-A408-11CF-B581-008029601108} | |
| 1011 | Prog_24 | Install | 2 | 1 | RESOURCES\*\SHELLEX\ | (Default) |
| | | | | | CONTEXTMENUHANDLERS\Prog_24 | |
| 1029 | Prog_25 | Install | 13 | 13 | RESOURCES\Prog_25\ | (Default) |
| | | | | | SHELLEX\PROPERTYSHEETHANDLERS\ | |
| | | | | | {B41DB860-8EE4-11D2-9906-E49FADC173CA} | |
| 1037 | Prog_26 | Install | 6 | 5 | RESOURCES\PHOTOSHOP.IMAGE.7\ | (Default) |
| | | | | | SHELLEX\PROPERTYSHEETHANDLERS\PSDPAGE | |
| 1043 | Prog_27 | Install | 0 | 7 | RESOURCES\ODCFILE\ | (Default) |
| | | | | | SHELLEX\ICONHANDLER | |
| 1069 | Prog_28 | Install | 0 | 593 | RESOURCES\WVXFILE\ | CheckSupportedTypes |
| | | | | | SHELLEX\CONTEXTMENUHANDLERS\ | |
| | | | | | Prog_28PLAYASPLAYLIST | |
| 1071 | Prog_29 | Normal | 0 | 222 | RESOURCES\WVXFILE\ | CheckSupportedTypes |
| | | | | | SHELLEX\CONTEXTMENUHANDLERS\ | |
| | | | | | Prog_29PLAYASPLAYLIST | |
| 1073 | Prog_30 | Install | 0 | 590 | RESOURCES\WVXFILE\ | CheckSupportedTypes |
| | | | | | SHELLEX\CONTEXTMENUHANDLERS\ | |
| | | | | | Prog_30PLAYASPLAYLIST | |
| 1184 | Prog_31 | Install | 0 | 4 | RESOURCES\AGENT.PREVIEW.2\ | (Default) |
| | | | | | SHELLEX\PROPERTYSHEETHANDLERS\ | |
| | | | | | CHARACTERPAGE | |
| 1188 | Prog_32 | Install | 0 | 6 | RESOURCES\OUTLOOK.TEMPLATE\ | (Default) |
| | | | | | SHELLEX\ICONHANDLER | |
| 1196 | Prog_33 | Install | 1 | 1 | RESOURCES\PEGFILE\SHELLEX\ | (Default) |
| | | | | | ICONHANDLER | |
| 1212 | Prog_34 | Install | 2 | 2 | RESOURCES\ACROEXCH.DOCUMENT\ | (Default) |
| | | | | | SHELLEX\PROPERTYSHEETHANDLERS\ | |
| | | | | | INFOPAGE | |
| 1216 | Prog_35 | Install | 1 | 0 | RESOURCES\CLSID\ | |
| | | | | | {955B7B84-5308-419C-8ED8-0B9CA3C56985}\ | |
| | | | | | SHELLEX\CONTEXTMENUHANDLERS\ | |
| | | | | | {955B7B84-5308-419C-8ED8-0B9CA3C56985} | |
| 1220 | Prog_36 | Install | 4 | 4 | RESOURCES\FOLDER\ | (Default) |
| | | | | | SHELLEX\CONTEXTMENUHANDLERS\ | |
| | | | | | Prog_36 | |
| 1230 | Prog_37 | Install | 0 | 3 | RESOURCES\ODCFILE\ | (Default) |
| | | | | | SHELLEX\ICONHANDLER | |
| 1237 | Prog_38 | Install | 0 | 8 | RESOURCES\WINZIP\SHELLEX\ | (Default) |
| | | | | | DROPHANDLER | |
| 1238 | Prog_39 | Normal | 0 | 8 | RESOURCES\WINZIP\SHELLEX\ | (Default) |
| | | | | | DROPHANDLER | |
| 1239 | Prog_40 | Uninstall | 0 | 2 | RESOURCES\FOLDER\SHELLEX\ | (Default) |
| | | | | | DRAGDROPHANDLERS\ | |
| | | | | | {BD472F60-27FA-11CF-B8B4-444553540000} | |
| 1242 | Prog_41 | Install | 0 | 3 | RESOURCES\ODCFILE\SHELLEX\ | (Default) |
| | | | | | ICONHANDLER | |
| 1284 | Prog_42 | Install | 62 | 62 | RESOURCES\WVXFILE\SHELLEX\ | (Default) |
| | | | | | CONTEXTMENUHANDLERS\ | |
| | | | | | Prog_42PLAYASPLAYLIST | |
| 1367 | Prog_43 | Install | 0 | 4 | RESOURCES\AGENT.PREVIEW.2\ | (Default) |
| | | | | | SHELLEX\PROPERTYSHEETHANDLERS\ | |
| | | | | | CHARACTERPAGE | |
| 1374 | Prog_44 | Install | 0 | 4 | RESOURCES\AGENT.PREVIEW.2\ | (Default) |
| | | | | | SHELLEX\PROPERTYSHEETHANDLERS\ | |
| | | | | | CHARACTERPAGE | |
| 1377 | Prog_45 | Install | 0 | 19 | RESOURCES\OUTLOOK.TEMPLATE\ | (Default) |
| | | | | | SHELLEX\ICONHANDLER | |
| 1397 | Prog_46 | Install | 4 | 11 | RESOURCES\ENVOY\ | (Default) |
| | | | | | SHELLEX\PROPERTYSHEETHANDLERS\ | |
| | | | | | ENVOYINFORMATIONPAGE | |
| 1398 | Prog_47 | Install | 4 | 11 | RESOURCES\ENVOY\SHELLEX\ | (Default) |
| | | | | | PROPERTYSHEETHANDLERS\ | |
| | | | | | ENVOYINFORMATIONPAGE | |
| 1444 | Prog_48 | Normal | 1 | 1 | RESOURCES\EXEFILE\SHELLEX\ | (Default) |
| | | | | | CONTEXTMENUHANDLERS\CMDLINEEXT | |
| 1454 | Prog_49 | Install | 9 | 6 | RESOURCES\NSTRANSFERREQUEST\ | (Default) |
| | | | | | SHELLEX\ICONHANDLER | |
| 1494 | Prog_50 | Install | 4 | 4 | RESOURCES\CORELDRAW.GRAPHIC.10\ | (Default) |
| | | | | | SHELLEX\PROPERTYSHEETHANDLERS\ | |
| | | | | | CDRSHELLPAGE | |
| 1537 | Prog_51 | Install | 0 | 9 | RESOURCES\VISIO.TEMPLATE.6\ | (Default) |
| | | | | | SHELLEX\ICONHANDLER | |
| 1561 | Prog_52 | Install | 1 | 1 | RESOURCES\PEGFILE\ | (Default) |
| | | | | | SHELLEX\ICONHANDLER | |
| 1564 | Prog_53 | Install | 0 | 1 | RESOURCES\DIRECTORY\SHELLEX\ | (Default) |
| | | | | | COPYHOOKHANDLERS\HESHELL | |
| 1569 | Prog_54 | Install | 0 | 5 | RESOURCES\XMLFILE\SHELLEX\ | (Default) |
| | | | | | ICONHANDLER | |
| 1580 | Prog_55 | Install | 0 | 3 | RESOURCES\.GHO\SHELLEX\ | (Default) |
| | | | | | {00021500-0000-0000-C000-000000000046} | |
| 1585 | Prog_56 | Install | 0 | 6 | RESOURCES\.GHO\SHELLEX\ | (Default) |
| | | | | | {00021500-0000-0000-C000-000000000046} | |
| 1590 | Prog_57 | Install | 0 | 4 | RESOURCES\FOLDER\SHELLEX\ | (Default) |
| | | | | | CONTEXTMENUHANDLERS\ | |
| | | | | | Prog_57CONTEXTMENU | |

TABLE A2
Exemplary data fields for a session group.

| Field Name | Field Type | Indexes | Description |
|---|---|---|---|
| Group ID | Integer | PK | Unique Group ID within |
| | | | database |
| Analysis ID | Integer | | Matches Analysis ID in |
| | | | Analyses table |
| Group Number | Integer | | Number of group within |
| | | | the analysis |
| Group Name | String | | Short name of group to be |
| | | | displayed |
| Group Type | String | | Type of group (e.g. “events”, |
| | | | “system” . . . ) |

TABLE A3
Exemplary data fields for each selected session member in a
session group.

| Field Name | Field Type | Indexes | Description |
|---|---|---|---|
| Group ID | Integer | FK1 | Matches Group ID in Groups table |
| Session ID | Integer | FK2 | Session included in group |

TABLE A4
Exemplary session logs for each session.

| | |
|---|---|
| Table Name | Description |

| | |
|---|---|
| Sessions | One record per logging session with details of machine |
| | and session |
| Points | Union of “points of fragility” from all sessions in the |
| | database |
| Access Types | Pre-set list of access types |
| Events | One record per combination of “Point” and “Access |
| | Type” |
| | Actual access events sharing the same point & type |
| | within a log are coalesced into a single “Event” record |
| Dll Stacks | Unique call stacks of DLLs/EXEs involved in access |
| | “Events” |

TABLE A5
Exemplary data fields for an interaction identified during a session.

| Table Name | Description |
|---|---|
| Analyses | One record per analysis with description etc |
| Groups | Groups of sessions involved in each analysis |
| Group Members | Sessions included in each group |
| Decisions | Decisions about various interactions entered by the |
| | user |
| Visibility | Current visibility state for entries within database |

TABLE A6
Exemplary data fields for each identified interaction.

| Field Name | Field Type | Indexes | Description |
|---|---|---|---|
| Point ID | Serial | PK | ID of potential “point of |
| | | | fragility” unique within |
| | | | database, shared by multiple |
| | | | sessions |
| Parent Point | Integer | FK1 | Point ID of parent point |
| Full Path | String | | Unique per category |
| Base Name | String | | Last name in full path or category |
| | | | name if parent is NULL |

TABLE A7
Exemplary data fields with corresponding descriptions of an access type.

| Field Name | Field Type | Indexes | Description |
|---|---|---|---|
| Access Type ID | Serial | PK | ID of access type |
| Description | String | | “Read”, “Write”, “Create”, |
| | | | “Delete”, . . . |
| Return Code | Integer | | Return code (optional) |

TABLE A8
Exemplary data fields recorded for each identified interaction or file access.

| Field Name | Field Type | Indexes | Description |
|---|---|---|---|
| Session ID | Integer | FK1, PK | Session this event is from |
| Point ID | Integer | FK2, PK | Fragility point being accessed |
| Access Type ID | Integer | FK3, PK | Type & Return Code of access performed |
| DLL Stack ID | Integer | FK4, PK | ID of DLL stack for events |
| Event Count | Integer | | Number of events represented in this record |
| First Size | Integer | | Size of file/key/. . . on first access |
| First Checksum | Integer | | Checksum of entire contents on first access |
| First Value | Variable | | Variably limited value on first access |
| First Type | Integer | | Type of data (from fixed table) |
| Last Size | Integer | | Size of file/key/. . . on last access |
| Last Checksum | Integer | | Checksum of entire contents on last access |
| Last Value | Variable | | Variably limited value on last access |

TABLE A9
Exemplary data fields for DLL stacks as a particular type of interactions.

| Field Name | Field Type | Indexes | Description |
|---|---|---|---|
| DLL Stack ID | Serial | PK | ID of DLL stack combination |
| Stack Sequence | String | SK | String of DLLs involved in call |

TABLE A10
Exemplary data fields collected for each application program in a
session group during an analysis of the session group.

| Field Name | Field Type | Indexes | Description |
|---|---|---|---|
| Analysis ID | Serial | PK | ID of this analysis |
| Analysis GUID | GUID | | GUID created at start of analsys |
| Initial Date | DateTime | | Time analysis was created |
| Initial User | String | | User who created analysis |
| Last Date | DateTime | | Time analysis was last changed |
| Last User | String | | User who last changed the analysis |
| Description | String | | Description for the analysis |
| Notes | String | | Ad hoc notes for the analysis |

TABLE A11
Exemplary data fields for each analysis decision.

| Field Name | Field Type | Indexes | Description |
|---|---|---|---|
| Analysis ID | Integer | FK1 | Analysis decision is being logged in |
| Point ID | Integer | FK2 | Access point decision refers to |
| Hierarchical | Boolean | | True if decision effects child points |
| Reason | String | | Terse reason |
| Notes | String | | Long notes on decision |
| Decision | Integer | | 1 = Ignore, 2 = Alert |

TABLE A12
Exemplary data fields for enabling filtering each identified interactions.

| Field Name | Field Type | Indexes | Description |
|---|---|---|---|
| Analysis ID | Integer | FK1 | Analysis decision is being logged in |
| Point ID | Integer | FK2 | Access point decision refers to |
| Visible | Boolean | | True if visible |
| Open | Boolean | | True if open beneath this point |

What is claimed is:

1. A computerized method for analyzing the impact of interactions of application programs with resources stored in a data store, said computerized method comprising:
receiving a selection of the application programs from a user;
identifying interactions of the resources by the selected application programs;
determining access types for each of the interactions of the resources by the selected application programs;
selecting a set of the identified interactions and the determined access types that corresponds to a map, said map including a predefined set of interactions having access types associated therewith; and
providing the map with the selected set of the identified interactions and the determined access types to the user.

2. The computerized method of claim 1, wherein providing further comprises visually indicating to the user potential conflicts among the selected set of the identified interactions and the determined access types, and wherein identifying comprises identifying interactions of the resources by the selected application programs during a particular time interval.

3. The computerized method of claim 1, further comprising creating a map by receiving a selection of interactions with associated access types from the user.

4. The computerized method of claim 1, further comprising storing the identified interactions and the determined access types in a memory area, wherein identifying the interactions comprises retrieving the stored interactions from the memory area, and wherein determining the access types comprises retrieving the stored access types from the memory area.

5. The computerized method of claim 1, wherein providing comprises providing the map having the selected set of identified interactions and the determined access types in a report in response to receiving a report request from the user, wherein the report includes one or more of the following: maps, the selected application programs, the identified interactions, and the determined access types.

6. The computerized method of claim 1, further comprising filtering the identified interactions by access type such that only the identified interactions having a particular access type are provided to the user.

7. The computerized method of claim 1, further defining a session type for the selected application programs, said session type includes an installation session, a normal session, and an uninstallation session, and wherein the access types include one or more of the following: create, open, read, write, and delete.

8. The computerized method of claim 1, wherein one or more computer-readable media have computer-executable instructions for performing the computerized method of claim 1.

9. A system for analyzing the impact of resource usage by application programs, said system comprising:
an interface for receiving a selection of a plurality of application programs from a user;
a memory for storing resources accessible by the selected set of application programs, said memory also storing a predefined set of maps, each of the predefined set of maps having access patterns therein; and
a processor for executing computer-executable instructions for:
identifying usage patterns of the resources by the selection of the plurality of application programs;
determining an access type associated with each of the identified usage patterns;
selecting one or more of the identified usage patterns and associated access types that correspond to a map, said map defining a predefined set of usage patterns and associated access types; and
displaying, via the interface, the map with the selected usage patterns and the associated access types to the user.

10. The system of claim 9, wherein the interface visually indicates to the user potential conflicts among usage patterns.

11. The system of claim 9, wherein the processor is further configured to filter the usage patterns by receiving from the user via the interface a selection of an access type such that the interface displays the usage patterns having the selected access type associated therewith.

12. The system of claim 9, wherein the processor is further configured to create a map by receiving a selection of usage patterns and associated access type from the user via the interface.

13. The system of claim 9, wherein the interface provides the selected interactions and associated access types in a report in response to receiving a report request from the user.

14. The system of claim 9, further comprising means for enabling analysis of the impact of interactions of the applications with the resources.

15. One or more computer-readable media having computer-executable components for analyzing file accesses by applications, said computer-executable components comprising:
a session component for enabling a user to select applications;
an analysis component for identifying file accesses by the selected applications, wherein said analysis component determines an access type for each of the identified file accesses;
a storage component for storing a map, said map including a predefined set of file accesses each having access types associated therewith;
a map component for correlating one or more of the identified file accesses and the determined access types to the predefined set of file accesses in the map; and
a display component for displaying the map having the correlated set of the identified file accesses and the determined access types to the user.

16. The computer-readable media of claim 15, wherein the display component visually indicates to the user potential file access conflicts among the selected applications.

17. The computer-readable media of claim 15, wherein the display component displays the map with the correlated file accesses and the determined access types in a report in response to receiving a report request from the user.

18. The computer-readable media of claim 15, wherein the analysis component filters the identified file accesses based on a particular access type.

19. The computer-readable media of claim 15, wherein the access types include one or more of the following: create a new file, create an existing file, create failure, create an unknown file, open a new file, open an existing file, open failure, open an unknown file, write a new file, write an existing file, write failure, write an unknown file, delete a new file, delete an existing file, delete failure, and delete an unknown file.

20. The computer-readable media of claim 15, wherein the storage component stores a plurality of maps.
